(19) United States
(12) Patent Application Publication
(10) Pub. No.: US 2009/0147043 A1
(43) Pub. Date: Jun. 11, 2009

(54) INKJET PRINTER COMPRISING INTEGRATED CAPPER AND CLEANER

(75) Inventor: Gregory John McAvoy, Balmain (AU)

Correspondence Address: SILVERBROOK RESEARCH PTY LTD, 393 DARLING STREET, BALMAIN, 2041, AU

(73) Assignee: SILVERBROOK RESEARCH PTY LTD.

(21) Appl. No.: 12/270,853

(22) Filed: Nov. 14, 2008

Related U.S. Application Data
(60) Provisional application No. 60/992,635, filed on Dec. 5, 2007.

(51) Int. Cl. B41J 2/165

(52) U.S. Cl. 347/32

(57) ABSTRACT

An inkjet printer comprising: a printhead having an ink ejection face; and a capper moveable between a first position in which said capper is disengaged from said printhead and a second position in which said capper is engaged with said printhead, said capper comprising: a capper body having a perimeter seal; at least one fluid inlet channel defined in said capper body; and at least one fluid outlet channel defined in said capper body, wherein, in said second position, said perimeter seal sealingly engages with said ink ejection face such that a cleaning chamber is defined between said capper body and said printhead, said cleaning chamber being in fluid communication with said at least one fluid inlet and said at least one fluid outlet.

### FIELD OF THE INVENTION

This invention relates to inkjet printhead maintenance. It has been developed primarily for facilitating maintenance operations, such as capping a printhead and cleaning particulates from an ink ejection face of the printhead.

### CO-PENDING APPLICATIONS

The following applications have been filed by the Applicant simultaneously with the present application:

| | |
|---|---|
| FNE042US | FNE043US |

The disclosures of these co-pending applications are incorporated herein by reference. The above applications have been identified by their filing docket number, which will be substituted with the corresponding application number, once assigned.

### CROSS REFERENCES TO RELATED APPLICATIONS

Various methods, systems and apparatus relating to the present invention are disclosed in the following U.S. patents/patent applications filed by the applicant or assignee of the present invention:

| | | | | | | |
|---|---|---|---|---|---|---|
| 7344226 | 7328976 | 11/685084 | 11/685086 | 11/685090 | 11/740925 | 11/763444 |
| 11/763443 | 11946840 | 11961712 | 12/017771 | 7367648 | 7370936 | 7401886 |
| 11/246708 | 7401887 | 7384119 | 7401888 | 7387358 | 7413281 | 11/482958 |
| 11/482955 | 11/482962 | 11/482963 | 11/482956 | 11/482954 | 11/482974 | 11/482957 |
| 11/482987 | 11/482959 | 11/482960 | 11/482961 | 11/482964 | 11/482965 | 11/482976 |
| 11/482973 | 11/495815 | 11/495816 | 11/495817 | 60992635 | 60992637 | 60992641 |
| 12050078 | 12050066 | 12138376 | 12138373 | 12142774 | 12140192 | 12140264 |
| 12140270 | 11/607976 | 11/607975 | 11/607999 | 11/607980 | 11/607979 | 11/607978 |
| 11/735961 | 11/685074 | 11/696126 | 11/696144 | 7384131 | 11/763446 | 6665094 |
| 7416280 | 7175774 | 7404625 | 7350903 | 11/293832 | 12142779 | 11/124158 |
| 6238115 | 6390605 | 6322195 | 6612110 | 6480089 | 6460778 | 6305788 |
| 6426014 | 6364453 | 6457795 | 6315399 | 6755509 | 11/763440 | 11/763442 |
| 12114826 | 12114827 | 12239814 | 12239815 | 12239816 | 11/246687 | 7156508 |
| 7303930 | 7246886 | 7128400 | 7108355 | 6987573 | 10/727181 | 6795215 |
| 7407247 | 7374266 | 6924907 | 11/544764 | 11/293804 | 11/293794 | 11/293828 |
| 11/872714 | 10/760254 | 7261400 | 11/583874 | 11/782590 | 11/014764 | 11/014769 |
| 11/293820 | 11/688863 | 12014767 | 12014768 | 12014769 | 12014770 | 12014771 |
| 12014772 | 11/482982 | 11/482983 | 11/482984 | 11/495818 | 11/495819 | 12062514 |
| 12192116 | 7306320 | 10/760180 | 6364451 | 7093494 | 6454482 | 7377635 |

### BACKGROUND OF THE INVENTION

Inkjet printers are commonplace in homes and offices. However, all commercially available inkjet printers suffer from slow print speeds, because the printhead must scan across a stationary sheet of paper. After each sweep of the printhead, the paper advances incrementally until a complete printed page is produced.

It is a goal of inkjet printing to provide a stationary pagewidth printhead, whereby a sheet of paper is fed continuously past the printhead, thereby increasing print speeds greatly. The present Applicant has developed many different types of pagewidth inkjet printheads using MEMS technology, some of which are described in the patents and patent applications listed in the cross reference section above.

The contents of these patents and patent applications are incorporated herein by cross-reference in their entirety.

Notwithstanding the technical challenges of producing a pagewidth inkjet printhead, a crucial aspect of any inkjet printing is maintaining the printhead in an operational printing condition throughout its lifetime. A number of factors may cause an inkjet printhead to become non-operational and it is important for any inkjet printer to include a strategy for preventing printhead failure and/or restoring the printhead to an operational printing condition in the event of failure. Printhead failure may be caused by, for example, printhead face flooding, dried-up nozzles (due to evaporation of water from the nozzles—a phenomenon known in the art as decap), or particulates fouling nozzles.

Accumulation of particulates on the printhead during idle periods should be avoided. Furthermore, particulates, in the form of paper dust, are a particular problem in high-speed pagewidth printing. This is because the paper is typically fed at high speed over a paper guide and past the printhead. Frictional contact of the paper with the paper guide generates large quantities of paper dust compared to traditional scanning inkjet printheads, where paper is fed much more slowly. Hence, pagewidth printheads tend to accumulate paper dust on their ink ejection face during printing. Any accumulation of particulates, either during idle periods or during printing, is highly undesirable.

In the worst case scenario, particulates block nozzles on the printhead, preventing those nozzles from ejecting ink. More usually, paper dust obscures nozzles resulting in misdirected ink droplets during printing. Misdirects are highly undesirable and may result in unacceptably low print quality.

Typically, printheads are capped during idle periods. In some commercial printers, a gasket-type sealing ring and cap engages around a perimeter of the printhead when the printer is idle. FIGS. 1A and 1B show schematically a prior art capping arrangement for an inkjet printhead. A printhead 1 comprises a plurality of nozzles 3 defined on an ink ejection face 4. A capper 2 comprises a rigid body 5 and a perimeter sealing ring 6. In FIG. 1B, the capper 2 is engaged with the printhead 1 so that the perimeter sealing ring 6 contacts and sealingly engages with the ink ejection face 4. The capper body 5, the sealing ring 6 and the ink ejection face 4 together define a capping chamber 7 when the capper 2 is engaged with the printhead 1. Since the capping chamber 7 is sealed, evaporation of ink from the nozzles 3 is minimized. An advantage of this arrangement is that the capper 2 does not make physical contact with the nozzles, thereby avoiding any damage to the nozzles. A disadvantage of this arrangement is that the capping chamber 7 still holds a relatively large volume of air, meaning that some evaporation of ink into the capping chamber is unavoidable.

Alternatively, FIGS. 2A and 2B show a contact capping arrangement for a printhead, whereby a capper 10 makes contact with the ink ejection face 4. Although this arrangement minimizes the problems of ink evaporation, contact between the capper 10 and the ink ejection face 4 is generally undesirable. In the first place, the ink ejection face is typically defined by a nozzle plate comprised of a hard ceramic material, which may damage a capping surface 11 of the capper 10. In the second place, contact between menisci of ink and the capper 10 results in fouling of the capping surface 11, and measures are usually required to clean the capping surface as well as the printhead.

Although not shown in FIGS. 1A and 1B, a vacuum may be connected to the capper 2 and used to suck ink from the nozzles 3. The vacuum sucks ink from the nozzles 3 and, in the process, unblocks any nozzles that may have dried out. A disadvantage of vacuum flushing is that it is very wasteful of ink—in many commercial inkjet printers, ink wastage during maintenance is responsible for a significant amount of the overall ink consumption of the printer.

In order to remove flooded ink from a printhead after vacuum flushing, prior art maintenance stations typically employ a rubber squeegee, which is wiped across the printhead. Particulates are removed from the printhead by flotation into the flooded ink and the squeegee removes the flooded ink having particulates dispersed therein.

However, rubber squeegees impart potentially damaging sheer forces across the printhead and require a separate maintenance step after the capper 2 has been disengaged from the printhead 1.

Therefore, it would be desirable to provide an inkjet printhead maintenance station, which does not rely on a rubber squeegee wiping across the printhead to remove flooded ink and particulates.

It would be further desirable to minimize evaporation of ink from the nozzles when the printhead is capped, whilst avoiding potentially damaging contact between the printhead and the capper.

It would be further desirable to avoid the use of a vacuum pump for printhead maintenance.

### SUMMARY OF THE INVENTION

In a first aspect the present invention provides an inkjet printer comprising:
a printhead having an ink ejection face; and
a capper moveable between a first position in which said capper is disengaged from said printhead and a second position in which said capper is engaged with said printhead, said capper comprising:
   a capper body having a perimeter seal;
   at least one fluid inlet channel defined in said capper body; and
   at least one fluid outlet channel defined in said capper body,
      wherein, in said second position, said perimeter seal sealingly engages with said ink ejection face such that a cleaning chamber is defined between said capper body and said printhead, said cleaning chamber being in fluid communication with said at least one fluid inlet and said at least one fluid outlet.

In a another aspect the printer further comprising:
a cleaning fluid reservoir in fluid communication with said at least one fluid inlet channel.

In a another aspect the printer further comprising:
a pump for pumping said cleaning fluid from said reservoir to said cleaning chamber via said at least one fluid inlet channel.

Optionally, said at least one inlet channel and said at least one outlet channel are arranged such that cleaning fluid enters said cleaning chamber via a central portion thereof and exits said cleaning chamber via a perimeter portion thereof.

Optionally, said cleaning fluid reservoir is in fluid communication with said at least one fluid outlet channel to provide a circulatory cleaning system.

Optionally, said cleaning system comprises one or more inline filters.

Optionally, said capper body is comprised of a resiliently deformable material.

Optionally, said capper is moveable into a third position, wherein said capper body is deformed into sealing engagement with said ink ejection face, thereby sealingly capping nozzles on said printhead.

Optionally, a capping surface of said capper body is comprised of a hydrophobic material.

Optionally, said ink ejection face is comprised of a hydrophobic material.

In another aspect the printer further comprising an engagement mechanism for moving said capper between said first position, said second position and said third position.

In a second aspect the present invention provides capper for cleaning and capping an inkjet printhead having an ink ejection face, said capper being moveable between a first position in which said capper is disengaged from said printhead and a second position in which said capper is engaged with said printhead, said capper comprising:
a capper body having a perimeter seal;
at least one fluid inlet channel defined in said capper body; and
at least one fluid outlet channel defined in said capper body,
   wherein, in said second position, said perimeter seal sealingly engages with said ink ejection face such that a cleaning chamber is defined between said capper body and said printhead, said cleaning chamber being in fluid communication with said at least one fluid inlet and said at least one fluid outlet.

Optionally, said capper body is comprised of a resiliently deformable material.

Optionally, said capper is moveable into a third position, wherein said capper body is deformed into sealing engagement with said ink ejection face, thereby sealingly capping nozzles on said printhead.

Optionally, a capping surface of said capper body is comprised of a hydrophobic material.

In a third aspect the present invention provides a method of cleaning a printhead having an ink ejection face, said method comprising the steps of:
(i) moving a capper into first engagement with said printhead, said capper comprising:
a capper body having a perimeter seal;
at least one fluid inlet channel defined in said capper body; and
at least one fluid outlet channel defined in said capper body,
   whereby said perimeter seal sealingly engages with said ink ejection face such that a cleaning chamber is defined between said capper body and said printhead, said cleaning chamber being in fluid communication with said at least one fluid inlet and said at least one fluid outlet; and
(ii) pumping cleaning fluid from a cleaning fluid reservoir to said cleaning chamber via said at least one fluid inlet channel, said cleaning fluid exiting said cleaning chamber via said at least one fluid outlet channel.

Optionally, said cleaning fluid flows across said ink ejection face to remove particulates therefrom.

Optionally, step (ii) further comprises recycling cleaning fluid exiting said cleaning chamber to said reservoir.

Optionally, step (ii) further comprises filtering said recycled cleaning fluid.

In a another aspect the present invention provides a method further comprising a capping step of:
(iii) moving said capper into second engagement with said printhead, wherein said capper body is deformed into sealing engagement with said ink ejection face, thereby sealingly capping nozzles on said printhead.

### BRIEF DESCRIPTION OF THE DRAWINGS

Specific forms of the present invention will be now be described in detail, with reference to the following drawings, in which:

FIG. 1A is a schematic transverse section of a prior art printhead maintenance arrangement comprising a printhead and perimeter capper;

FIG. 1B is a schematic transverse section of the printhead maintenance arrangement shown in FIG. 1A with the perimeter capper engaged with the printhead;

FIG. 2A is a schematic transverse section of a prior art printhead maintenance arrangement comprising a printhead and contact capper;

FIG. 2B is a schematic transverse section of the printhead maintenance arrangement shown in FIG. 2A with the contact capper engaged with the printhead;

FIG. 3A is a schematic transverse section of the printhead maintenance arrangement according to the invention comprising a printhead and capper;

FIG. 3B is a schematic transverse section of the printhead maintenance arrangement shown in FIG. 3A configured for a printhead cleaning cycle; and

FIG. 3C is a schematic transverse section of the printhead maintenance arrangement shown in FIG. 3A configured for printhead capping.

### DETAILED DESCRIPTION OF SPECIFIC EMBODIMENTS

### Integrated Capper and Cleaner

As foreshadowed above, prior art printhead maintenance stations typically employ vacuum suction in combination with a capper to forcibly unblock ‘decapped’ nozzles. Following vacuum suction, any ink flooded across the ink ejection face of the printhead is removed by a squeegee, which wipes across the ink ejection face, removing particulates at the same time.

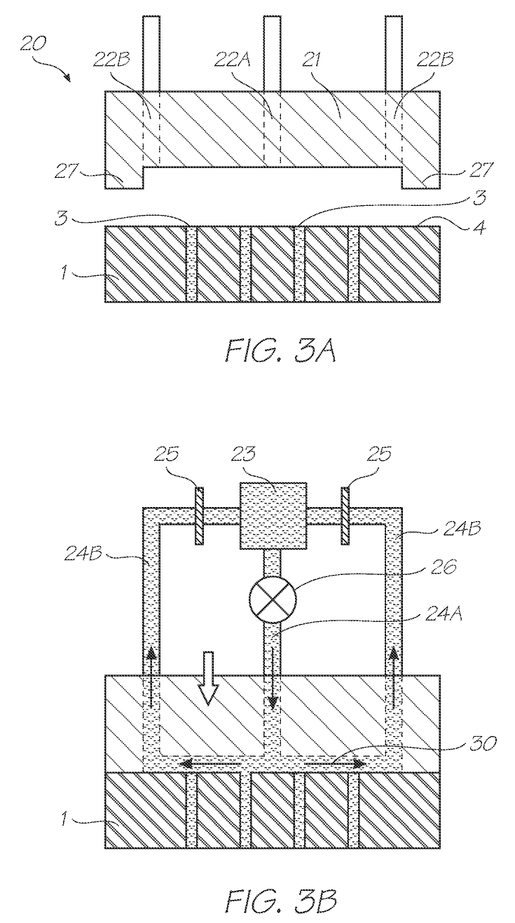

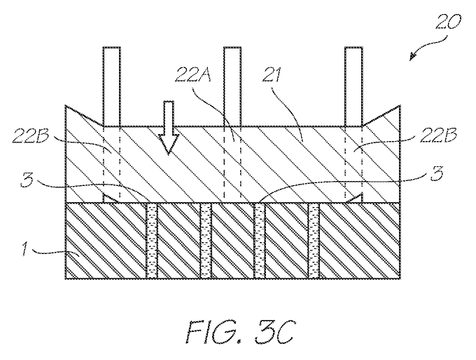

FIG. 3 shows a printhead maintenance arrangement according to the present invention, whereby a capper 20 performs a plurality of functions, including printhead cleaning and capping. Referring to FIGS. 3A and 3B, the capper 20 comprises a body 21 having a plurality of cleaning channels 22 defined therein. The central channel 22A is an inlet channel, whilst the pair of outer channels 22B are outlet channels.

The inlet channel 22A is connected via an inlet conduit 24A to a reservoir 23 of cleaning fluid. The outlet channels 22B are either connected to a sink or they may recycle cleaning fluid to the reservoir 23 via outlet conduits 24B, as shown in FIG. 3B. In the circulatory system shown in FIG. 3B, each outlet conduit 24B comprises an inline filter 25, which removes particulates from the cleaning fluid before it is returned to the reservoir 23. The filters 25 may be replaceable or they may last the lifetime of the printer. A pump 26 positioned in the inlet conduit 24A, between the reservoir 23 and the inlet channel 22A of the capper 20, is used to pump the cleaning fluid through the system.

In a first stage of printhead maintenance shown in FIG. 3B, the capper 20 is engaged with the printhead 1 by sealingly engaging a perimeter sealing ring 27 of the capper with the ink ejection face 4 of the printhead. With the sealing ring 27 contacting the ink ejection face 4, a cleaning chamber 30 is formed above the nozzles 3. The cleaning chamber 30 is defined by the ink ejection face 4, the perimeter sealing ring 27 and the capper body 21.

Once the capper 20 is engaged with the printhead 1, cleaning fluid is pumped from the reservoir 23 using the pump 26. The cleaning fluid is pumped into a central portion of the cleaning chamber 30 via the inlet channel 22A and exits via the outlet channels 22B. The cleaning fluid flowing across the ink ejection face 4 removes particulates both by flotation and the force of the fluid flow. Examples of suitable cleaning fluids are water, ethylene glycol solution, a dyeless ink vehicle or even ink.

Any nozzles which have become blocked due to evaporation of ink will be rapidly unblocked during the cleaning cycle. The generally aqueous-based cleaning fluid rehydrates the ink in each nozzle, thereby unblocking any decapped nozzles. Advantageously, the cleaning fluid is a dyeless ink vehicle matching the ink vehicle for inks ejected by the nozzles. This helps to maintain, for example, a pH balance with the inks and minimizes any undesirable precipitation from the inks as a result of mixing with the cleaning fluid.

A plurality of inlet channels 22A and outlet channels 22B may be defined in the capper 20 to control flow of the cleaning fluid across the ink ejection face 4. For example, it may be advantageous to encourage flow of cleaning fluid longitudinally along nozzle rows, rather than transversely across nozzle rows, so as to minimize color-mixing on the ink ejection face 4. The skilled person will be able to envisage many different arrangements of inlet and outlet channels 22 in order to provide optimal flow of cleaning fluid.

Preferably, the capper body 21 is comprised of a flexible, resilient material, which enables a second stage of printhead maintenance following the cleaning cycle shown in FIG. 3B. Referring now to FIG. 3C, further pressure on the capper 20 deforms the body 21, and forces a surface of the body into engagement with the ink ejection face 4. During this engagement, the cleaning fluid is forced from the cleaning chamber 30 and exits through the channels 22. Hence, the compliant capper body 21 contacts the cleaned ink ejection face 4 and seals the nozzles 3.

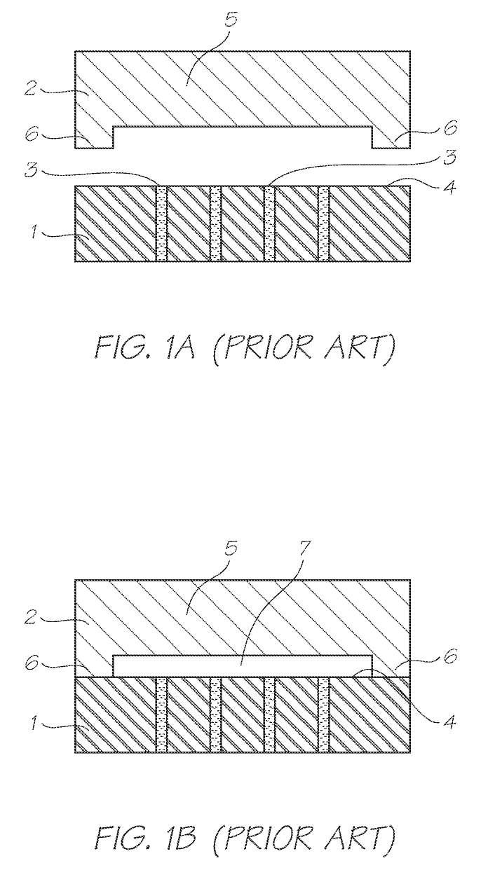

In contrast with the arrangement shown in FIG. 1B, since there is not a large volume of air above each nozzle 3, the capped state shown in FIG. 3C has minimal evaporation of ink from the nozzles.

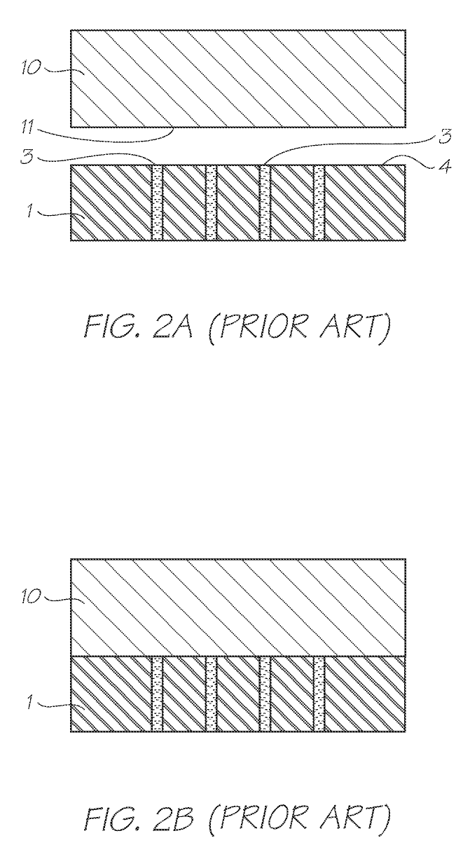

Moreover, in contrast with the arrangement shown in FIG. 2B, any fouling of the capper 20 during capping is not problematic, because the capper as well as the printhead is cleaned during the cleaning cycle described above. A further cleaning cycle after capping the printhead may also be employed, if required.

The capper body 21 may be formed of any suitable compliant material. The present invention is particularly efficacious when the capper body 21 and/or the ink ejection face 4 are both relatively hydrophobic. Accordingly, the capper body 21 may be comprised of materials such as silicones, polyolefins (e.g. polyethylene, polypropylene), polyurethanes, Neoprene®, Santoprene® or Kraton®. We have previously described printheads 1 having a hydrophobic ink ejection face 4 by virtue of an exterior layer of, for example, polydimethylsiloxane (PDMS) or perfluorinated polyethylene (PFPE). Such printheads were described in our earlier U.S. application Ser. No. 11/685,084 filed on Mar. 12, 2007, the contents of which is herein incorporated by reference.

Although not shown in FIG. 3, any suitable mechanism may be used to engage and disengage the capper 20 from the printhead 1. The capping mechanism should be preferably configured to provide a first disengaged position (FIG. 3A), a second cleaning engagement position (FIG. 3B) a third capping engagement position (FIG. 3C). For example, in our earlier US Publication No. 2007/126784, the contents of which is herein incorporated by reference, we described a mechanism for linearly bringing a cleaning belt into engagement with a printhead. The skilled person will appreciate that such a mechanism may be readily modified for use with the integrated capper/cleaner arrangement of the present invention.

The capping arrangement of the present invention, described in connection with FIGS. 3A to 3C, has a number of significant advantages:
the capper 20 is an integrated capper and cleaner, which avoids the need for separate capping and cleaning mechanisms;
the capper 20 and printhead 1 are both cleaned during a cleaning cycle. This avoids the build of ink deposits on the capper;
printhead cleaning is non-contact, which avoids any sheer forces exerted by, for example, a squeegee wiper blade;
the cleaning cycle is sealed, which facilitates particulate removal by, for example, filtration;
there are minimal alignment issues due to the compliance of the capper body 21. Hence, any capping mechanism does not require high tolerances to bring the capper into exact alignment with the printhead;
wastage of printing ink is avoided, because the cleaning fluid is supplied separately from ink supplied to the nozzles;
any cleaning fluid may be used, including dyeless ink vehicles. Printhead cleaning is not limited to inks supplied by the nozzles.

It will, of course, be appreciated that the present invention has been described purely by way of example and that modifications of detail may be made within the scope of the invention, which is defined by the accompanying claims.

1. An inkjet printer comprising:
a printhead having an ink ejection face; and
a capper moveable between a first position in which said capper is disengaged from said printhead and a second position in which said capper is engaged with said printhead, said capper comprising:
a capper body having a perimeter seal;
at least one fluid inlet channel defined in said capper body; and
at least one fluid outlet channel defined in said capper body,
wherein, in said second position, said perimeter seal sealingly engages with said ink ejection face such that a cleaning chamber is defined between said capper body and said printhead, said cleaning chamber being in fluid communication with said at least one fluid inlet and said at least one fluid outlet.

2. The printer of claim 1, further comprising:
a cleaning fluid reservoir in fluid communication with said at least one fluid inlet channel.

3. The printer of claim 2, further comprising:
a pump for pumping said cleaning fluid from said reservoir to said cleaning chamber via said at least one fluid inlet channel.

4. The printer of claim 1, wherein said at least one inlet channel and said at least one outlet channel are arranged such that cleaning fluid enters said cleaning chamber via a central portion thereof and exits said cleaning chamber via a perimeter portion thereof.

5. The printer of claim 2, wherein said cleaning fluid reservoir is in fluid communication with said at least one fluid outlet channel to provide a circulatory cleaning system.

6. The printer of claim 5, wherein said cleaning system comprises one or more inline filters.

7. The printer of claim 1, wherein said capper body is comprised of a resiliently deformable material.

8. The printer of claim 7, wherein said capper is moveable into a third position, wherein said capper body is deformed into sealing engagement with said ink ejection face, thereby sealingly capping nozzles on said printhead.

9. The printer of claim 8, wherein a capping surface of said capper body is comprised of a hydrophobic material.

10. The printer of claim 8, wherein said ink ejection face is comprised of a hydrophobic material.

11. The printer of claim 8, further comprising an engagement mechanism for moving said capper between said first position, said second position and said third position.

12. A capper for cleaning and capping an inkjet printhead having an ink ejection face, said capper being moveable between a first position in which said capper is disengaged from said printhead and a second position in which said capper is engaged with said printhead, said capper comprising:
a capper body having a perimeter seal;
at least one fluid inlet channel defined in said capper body; and
at least one fluid outlet channel defined in said capper body,
wherein, in said second position, said perimeter seal sealingly engages with said ink ejection face such that a cleaning chamber is defined between said capper body and said printhead, said cleaning chamber being in fluid communication with said at least one fluid inlet and said at least one fluid outlet.

13. The capper of claim 12, wherein said capper body is comprised of a resiliently deformable material.

14. The capper of claim 13, wherein said capper is moveable into a third position, wherein said capper body is deformed into sealing engagement with said ink ejection face, thereby sealingly capping nozzles on said printhead.

15. The capper of claim 14, wherein a capping surface of said capper body is comprised of a hydrophobic material.

16. A method of cleaning a printhead having an ink ejection face, said method comprising the steps of:
(i) moving a capper into first engagement with said printhead, said capper comprising:
a capper body having a perimeter seal;
at least one fluid inlet channel defined in said capper body; and
at least one fluid outlet channel defined in said capper body,
whereby said perimeter seal sealingly engages with said ink ejection face such that a cleaning chamber is defined between said capper body and said printhead, said cleaning chamber being in fluid communication with said at least one fluid inlet and said at least one fluid outlet; and
(ii) pumping cleaning fluid from a cleaning fluid reservoir to said cleaning chamber via said at least one fluid inlet channel, said cleaning fluid exiting said cleaning chamber via said at least one fluid outlet channel.

17. The method of claim 16, wherein said cleaning fluid flows across said ink ejection face to remove particulates therefrom.

18. The method of claim 16, wherein step (ii) further comprises recycling cleaning fluid exiting said cleaning chamber to said reservoir.

19. The method of claim 17, wherein step (ii) further comprises filtering said recycled cleaning fluid.

20. The method of claim 17, further comprising a capping step of:
(iii) moving said capper into second engagement with said printhead, wherein said capper body is deformed into sealing engagement with said ink ejection face, thereby sealingly capping nozzles on said printhead.
